(19) United States
(12) Patent Application Publication
(10) Pub. No.: US 2025/0100904 A1
(43) Pub. Date: Mar. 27, 2025

(54) Multi-range ultrasonic algae control

(71) Applicant: Antonio Davido Trigiani, Bristol, TN (US)

(72) Inventor: Antonio Davido Trigiani, Bristol, TN (US)

(21) Appl. No.: 18/891,924

(22) Filed: Sep. 20, 2024

Related U.S. Application Data
(60) Provisional application No. 63/584,794, filed on Sep. 22, 2023.

(51) Int. Cl. C02F 1/36; B06B 1/02; B06B 1/06; C02F 103/00; C02F 103/42

(52) U.S. Cl. CPC C02F 1/36; B06B 1/0284; B06B 1/0625; B06B 2201/74; C02F 2103/007; C02F 2103/42; C02F 2303/20

(57) ABSTRACT

Apparatus for controlling algae and bio-organisms in bodies of liquids, such as water. The algae control system includes a first set of ultrasonic transducers and a second set of ultrasonic transducers where at least the second set of transducers emits ultrasonic waves 360 degrees around a vertical axis of a submergible sonic head that includes the sets of transducers. The first set of transducers are controlled to emit ultrasonic waves within a first range of frequencies with a first selected duty cycle and said second set of transducers are controlled to emit ultrasonic waves within a second range of frequencies with a second selected duty cycle. The first and second range of frequencies target different species of organisms. The second set of transducers include one or more groups of transducers that are spaced horizontally around the vertical axis of the sonic head. The multiple groups operate independently of each other.

### CROSS-REFERENCE TO RELATED APPLICATIONS

This application claims the benefit of U.S. Provisional Application No. 63/584,794, filed Sep. 22, 2023.

### STATEMENT REGARDING FEDERALLY SPONSORED RESEARCH OR DEVELOPMENT

Not Applicable

### BACKGROUND

### 1. Field of Invention

This invention pertains to an apparatus for controlling algae and bio-organisms in bodies of water and for preventing layered bacterial formation (biofilm) where algae can attach on surfaces in that body of water. More particularly, this invention pertains to a power system and multiple sets of ultrasonic transducers that radiate in all directions in a plane to induce a sensation of turbulence to anaerobic bacterial organisms and/or affect a microorganism's gas vacuoles.

### 2. Description of the Related Art

Ultrasonic algae control systems are used to control the undesirable growth of algae in bodies of water. Algae is a large, diverse group of photosynthetic organisms that often thrive in a water environment. When a body of water has an abundance of nutrients, algae thrives. Depending upon the type of algae, the algae growth may be beneficial or detrimental to the health of the body of water. For example, filamentous green algae and blue-green algae (Cyanobacteria) are known for adversely affecting the health of a body of water when they grow in abundance.

Ultrasonic algae control systems include a sonic head that is submerged in a body of water. The sonic head includes one or more ultrasonic transducers that direct ultrasonic waves into the water. It is known to generate ultrasonic waves from ultrasonic transducers that incorporate a piezoelectric crystal. Blocks are attached to the crystal to enhance the transmission of the ultrasonic waves into fluid or liquid, such as water, from the crystal. One type of transducer uses a single block attached to one face of the crystal. Another type uses two blocks, each attached to an opposing face of the piezoelectric crystal. The blocks are affixed to the crystal in various ways, for example, by adhesives or by a fastener that compresses the crystal against the one or more blocks.

### BRIEF SUMMARY

According to one embodiment of the present invention, a multi-range ultrasonic algae control system is provided. The algae control system has a sonic head configured to be submerged in a body of water. The sonic head includes a first set of ultrasonic transducers and a second set of ultrasonic transducers where each set of transducers operates within different frequency ranges. The ultrasonic waves or vibrations are emitted in a plane substantially parallel with the surface of the body of water when the two sets of transducers are positioned in the body of water. In one embodiment, each of the sets of transducers radiate ultrasonic waves 360 degrees around the sonic head in a pulsing manner that induces a sensation of turbulence to anaerobic bacterial organisms that normally colonize surfaces to create biofilm habitats for themselves plus aerobic bacteria and algae. The apparatus thus creates a condition in water that to anaerobic bacteria interpret as water turbulence, that is, a place in nature where habitation is not normally possible for them.

The first set of transducers, in one embodiment, include a pair of transducers that each emit ultrasonic waves in two opposite directions along a respective axis. The first set of transducers is configured to emit ultrasonic waves at a low frequency (for example, less than 500 kHz) with 360 degree horizontal coverage. In another embodiment, the first set of transducers includes a transducer that emit ultrasonic waves in two opposite directions along an axis. In yet another embodiment, the first set of transducers include a single piezoelectric element that has a cylindrical shape with four radiators positioned around the circumference such that ultrasonic waves are transmitted with 360 degree horizontal coverage. The first set of transducers emits sonic waves in a frequency band that targets green algae and diatom algae and in another frequency band that targets blue-green algae with gas vesicles, and a high frequency range that targets much smaller algae types such as dinoflagellate, also known as red tide algae.

The second set of transducers include, in one embodiment, four transducers that each emit ultrasonic waves in one direction along a respective axis. The second set of transducers is configured to emit ultrasonic waves at selected frequencies, for example between 500 kHz and 1500 kHz, with 360 degree horizontal coverage. In other embodiments, the second set of transducers include multiple groups of transducers with each group arranged around the sonic head such that each group emits ultrasonic waves at selected frequencies with 360 degree horizontal coverage. In one such embodiment, the second set of transducers includes two groups of four transducers, each group independently operable with the four transducers of each group positioned at 90 degree intervals around the vertical axis of the sonic head.

The second set of transducers targets smaller algae, such as those composing red tide algae. In one embodiment, each transducer in the second set of transducers includes a piezoelectric element attached to an inside surface of a housing such that the ultrasonic waves will be emitted in only the outward direction. In one such embodiment, each piezoelectric element has a block on the surface of the piezoelectric element inside the housing. In one embodiment, the housing for the second set of transducers is a driver housing that also includes a printed circuit board with the components that drive the first and second sets of transducers.

The second set of transducers, in one embodiment, includes a group of four transducers spaced at 90 degrees around the vertical axis of the sonic head. With this configuration, the group of four transducers provides 360 degrees of ultrasonic waves around the sonic head. In other embodiments, the second set of transducers include multiple groups of transducers with the transducers of each group spaced at 90 degrees around the vertical axis of the sonic head and the transducers of one group offset from the transducers of the other groups. For example, when the second set of transducers includes two groups, each of the transducers of the second group are offset 45 degrees from the adjacent transducer for the first group. In another embodiment, the second group is positioned vertically below the first group.

In one embodiment, the transducer unit includes a single sonic head that provide planar coverage at a single depth parallel to the surface of the water. In other embodiments, the transducer unit includes two or more sonic heads disposed at different depths below the surface of the water. In this way, the multiple sonic heads provide coverage vertically, for example, to control algae growth on a fishing net or underwater structure. In one such embodiment, a single cable connects all the sonic heads to the power supply unit. In another embodiment, a series of parallel connected cables connect the sonic heads to the power supply unit.

The power supply unit provides power and control signals to the transducer unit. In one embodiment, the power supply unit includes a processor and communications module, a solar panel, a charger, and a battery. In another embodiment the power unit includes a connection to an external mains supply. The processor allows for local control through various switches, a keyboard, and a display and for remote control through the communications module via a hardwired or wireless connection.

The transducer unit in one configuration includes a float that suspends a sonic head below the surface of a body of water where algae control is desired. In another configuration the transducer unit includes a buoyant portion supporting the sonic head, where the buoyant portion is anchored or secured to the bottom, thereby positioning the sonic head a distance above the bottom. In yet another configuration the transducer unit is secured to the bottom or another underwater surface with the sonic head supported between the surface and the bottom. The sonic head includes a driver and a transducer subassembly. The driver includes a processor, a power supply, and an exciter.

The control system driving the transducers considers factors including the frequency range and bandwidth, the time on/off (the duty cycle) at each discrete frequency, the step change from one frequency to the next, the power setting per frequency, and the size of the body of water in order to target a particular microorganism. These factors are programmable for specific applications, and, in one embodiment, the control system is remotely programmed. In this way the algae control system improves the control zone area per watt of energy consumed by configuration of the piezoelectric transducer and by voltage drop sensing and compensation in the device circuit to prevent loss of sound output levels. Also, the feature of installing programmed voltage set points for each ultrasonic frequency generated serves to maintain a consistent sound pressure output across the frequency bandwidths, which increases the overall range of control effectiveness.

In this way, the algae control system increases the frequency density in specific bandwidths where the microorganism control phenomenon of critical structural resonance occurs. The increased number of frequencies and frequency ranges, increases the number of microorganisms that can be controlled. Also, operating the algae control system within multiple frequency bandwidths enables targeting various microorganisms, for example, cyanobacteria (blue-green algae).

### BRIEF DESCRIPTION OF THE SEVERAL VIEWS OF THE DRAWINGS

The above-mentioned features will become more clearly understood from the following detailed description read together with the drawings in which:

FIG. 1 is a symbolic view of one embodiment of the algae control system.

FIG. 2 is a perspective view of one embodiment of sonic head.

FIG. 3 is a top view of the embodiment of a sonic head shown in FIG. 2.

FIG. 4 is a top view of one embodiment of an inside of the driver housing of the sonic head shown in FIG. 2.

FIG. 5 is a cross-sectional view of one embodiment of the driver housing shown in FIG. 3.

FIG. 6 is a partial cross-sectional view of another embodiment of the driver housing showing three groups of the second set of transducers.

FIG. 7 is a block diagram of one embodiment of the algae control system.

FIG. 8 is an exploded diagram showing one embodiment of a transducer subassembly.

FIG. 9 is an exploded diagram of one embodiment of a sonic head.

FIG. 10 is a block diagram of another embodiment of a power supply unit.

FIG. 11 is a block diagram of another embodiment of a sonic head.

FIG. 12 is a partial cross-sectional view of a first embodiment of a transducer from the second set of transducers.

FIG. 13 an exploded diagram of a second embodiment of a transducer from the second set of transducers.

FIG. 14 is plan view of the second embodiment of a piezoelectric element.

FIG. 15 is a cross-sectional view of the second embodiment of a block.

FIG. 16 is an exploded diagram of a third embodiment of a transducer from the second set of transducers.

### DETAILED DESCRIPTION

Apparatus for an algae control system 100 is disclosed. Various components and elements, such as the first and second transducers 714-A, 714-B, have their particular embodiments and variations shown in the figures and described below with an alphabetic suffix. When referencing those components and elements generally, though, the suffix is omitted, such as when referencing the first set of transducers 714. Positional references, such as horizontal and vertical, refer to the configuration of the algae control system 100 as it is deployed for use. For example, horizontal is considered parallel to the surface of the body of water 102 when the sonic head 114 is deployed in the water 102 and vertical is perpendicular to that horizontal.

FIG. 1 illustrates a symbolic view of one embodiment of the multi-range ultrasonic algae control system 100. The algae control system 100 includes a power supply unit 120 electrically connected to a transducer unit 110. The algae control system 100 is configured to be used with a body of water 102, such as a lake, a stream or river, a pond, a swimming pool, a spa or hot tub, or other liquid in which algae overgrowth is to be controlled or eliminated.

The illustrated embodiment of the transducer unit 110 includes a floating device. The transducer unit 110 includes a float 112 with a flag 136, a sonic head 114, and an anchor system 118. The float 112 and anchor system 118 define the support structure for the sonic head 114. The support structure supports the sonic head 114 at a desired position and depth in the body of water 102.

The transducer unit 110 is configured to float in a body of water 102, such as a pond, reservoir, or small lake. The float 112 is buoyant and rests on or near the surface 104 of the body of water 102. The float 112 has sufficient buoyancy to support the floating transducer unit 110 and a portion of the cable 126 with the float 112 at the surface 104 of the water 102. Extending above the float 112 is a flag 136. The flag 136 has a flag pole and a banner with markings. The flag 136 warns boaters and other waterborne users that there is an electrical device present in the vicinity.

Suspended below the float 112 is the sonic head 114. The sonic head 114 is generally 0.3 to 0.4 meters below the surface 104 of the water 102, although the depth of the sonic head 114 varies based on the requirements of the specific application configuration. For example, in a swimming pool or hot tub, the depth of the water 102 is such that the sonic head 114 provides adequate coverage when mounted on or near the bottom 106. In one such embodiment, the sonic head 114 is supported by an attachment to the bottom or sidewall of the pool or tub.

The float 112 is anchored to the bottom 106 of the body of water 102 by the anchor system 118. The anchor system 118 includes an anchor line 132 and an anchor 134 that engages the bottom 106. In one embodiment the sonic head 114 has an upper attachment point 202 for connecting to the float 112 and a lower attachment point 202 for connecting to the anchor system 118. In another embodiment the anchor system 118 is attached to the float 112 and the sonic head 114 attaches to the anchor line 132.

In another embodiment of the transducer unit 110, the sonic head 114 is buoyant or is attached to a float, and the sonic head 114 is secured to the bottom 106 with an anchor 134. The length of the anchor line 132 between the sonic head 114 and the anchor 134 establishes the depth of the sonic head 114 below the surface 104 of the body of water 102.

In yet another embodiment of the transducer unit 110, the transducer unit 110 is secured to a support surface, such as a wall or bottom 106 of the body of water 102, with the sonic head 114 protruding from the support surface into the body of water 102. Such an embodiment is suitable for a body of water 102 that is a small pond or a swimming pool where the volume of water to be treated by the transducer unit 110 is small enough that the horizontal position of the sonic head 114 is not critical to ensuring that the algae is controlled. For such a body of water 102, the transducer unit 110 protruding from the support surface is unobtrusive while still being effective.

The illustrated power supply unit 120 is positioned on land 108 next to the body of water 102. The power supply unit 120 includes at least one solar panel 124 and a power unit 122, which provides power when a mains power supply is not available. In another embodiment, the power supply unit 120 is connected to a mains supply 702. A cable 126 connects the power supply unit 120 to the transducer unit 110. The cable 126 provides power and bidirectional control signals to and from the transducer unit, or sonic head, 110.

In another embodiment the power supply unit 120 includes a floating platform that is anchored in the body of water 102. For example, the power supply unit 120 is supported by dock floats, which are also the float 112 that forms part of the floating transducer unit 110. The power unit 122, battery pack 722, and solar panel 124 secured above the surface 104 of the body of water 102 by the float 112. In this way the power supply unit 120 and the floating transducer unit 110 are an integral unit. The integral combination of the power supply unit 120 and floating transducer unit 110 is able to be powered solely from the solar panel 124 (and associated battery 722) without reliance upon a mains power source 702. A further advantage of the integral combination is that the cable 126 has a short length, thereby minimizing power loss due to conductor resistance. In yet another embodiment, the power supply unit 120 and the floating transducer unit 110 are an integral unit configured to be secured or attached to a structure in or defining the body of water 102, for example, the wall or floor of a swimming pool.

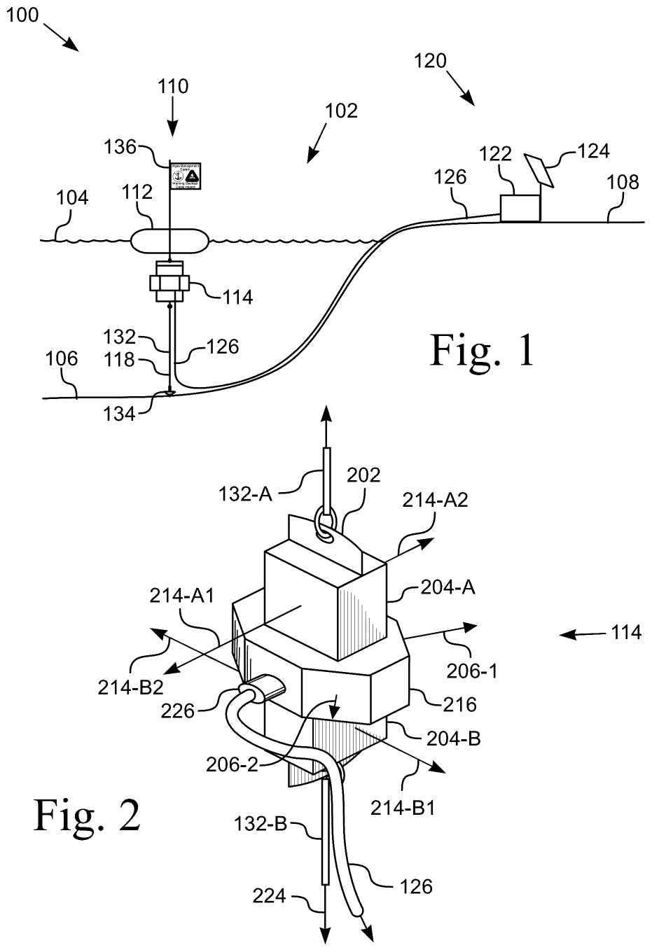

FIG. 2 illustrates a perspective view of one embodiment of sonic head 114. In the illustrated embodiment, the sonic head 114 includes a pair of tabs 202 for attaching the anchor system 118. The upper anchor line 132-A connects the top tab 202 of the sonic head 114 to a support, such as the float 112. The upper anchor line 132-A has a length sufficient to hold the sonic head 114 at a desired depth below the surface 104. The lower anchor line 132-B attaches the bottom tab 202 of the sonic head 114 to the anchor 134 resting on the bottom 106. In another embodiment the float 112 is connected directly to the top tab 202 of the sonic head 114 without the use of an upper anchor line 132-A.

The sonic head 114 includes an upper transducer housing 204-A, a second housing 216, and a lower transducer housing 204-B. A portion of the cable 126 runs along the lower anchor line 132-B, is secured to the lower tab 202 for strain relief, and has an end connector 226 mating with a connector 426 in the second housing 216. In another embodiment, the sonic head 114 includes a single transducer housing 204 located either above or below the second housing 216.

The illustrated upper and lower transducer housings 204-A, 204-B are positioned such that a first set of emitted sonic waves 214-A, 214-B are at right angles to each other. The axis 214-A extending through the upper housing 204-A shows the axis 214-A1, 214-A2 of two opposing sonic waves from the upper transducer 714-A. The axis 214-B extending through the lower housing 204-B shows the axis 214-B1, 214-B2 of two opposing sonic waves from the lower transducer 714-B. The first set of emitted sonic waves are emitted and spread around the axes 214-A, 214-B. In this way the upper and lower transducers 714-A, 714-B provide the first set of sonic waves emitted radially 360 degrees in a plane below the surface 104 centered at the sonic head 114. In the embodiment with only a single transducer housing 204, the sonic waves 214 are emitted in two directions that are 180 degrees apart.

The second, or driver, housing 216 includes a second set of transducers 402 that include one or more groups of transducers 402. Each group of transducers are configured to emit one of a second set of emitted sonic waves radially 360 degrees in a plane below the surface 104 centered at the sonic head 114. Each of the second set of transducers 402 has an axis 206 that extends away from the sonic head 114 and about which the emitted ultrasonic wave is centered.

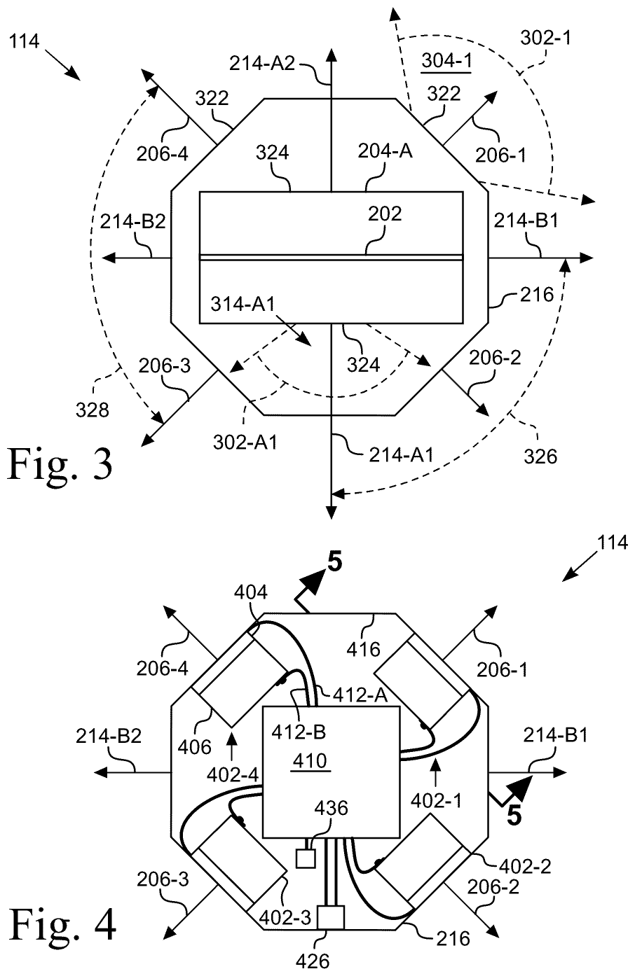

FIG. 2 illustrates the axes 214, 206 for the various transducers 714, 402 in the sonic head 114. FIG. 3 illustrates a top view of the embodiment of the sonic head 114 shown in FIG. 2. FIG. 4 illustrates a top view of one embodiment of an inside of the driver housing 216 of the sonic head 114 shown in FIG. 2.

The first set of transducers 714 includes multiple radiating surfaces 324 on the outside of the transducer housing 204. Each radiating surface 324 has an axis 214 that passes perpendicularly through the surface 324. The axis 214-A1, 214-A2 passes through the upper transducer housing 204-A. The axis 214-A1, 214-A2 corresponds to the center of the ultrasonic wave emitted from each side of the upper transducer housing 204-A. The axis 214-B1, 214-B2 passes through the lower transducer housing 204-B. The axis 214-B1, 214-B2 corresponds to the center of the ultrasonic wave emitted from each side of the lower transducer housing 204-B. The axes 214-A1, 214-A2, 214-B1, 214-B2 for the first set of transducers 714 are positioned at 90 degree intervals 326 around the vertical axis 224 of the sonic head 114.

In the illustrated embodiment, the second set of transducers 402 includes one group of transducers 402-1, 402-2, 402-3, 402-4 with each transducer 402 having a radiating surface 322 on the outside of the housing 216. Each radiating surface 322 has an axis 206 that passes perpendicularly through the radiating surface 322. The axis 206 defines the center of the radiating volume of the ultrasonic waves 304 emitted from each transducer 402. Each of the axes 206-1, 206-2, 206-3, 206-4 passes through a corresponding one of the transducers 402-1, 402-2, 402-3, 402-4 of the second set of transducers 402 inside the driver housing 216. Each of the axes 206-1, 206-2, 206-3, 206-4 corresponds to the center of the ultrasonic wave emitted from the outer surface of each one of the second set of transducers 402-1, 402-2, 402-3, 402-4. The axes 206-1, 206-2, 206-3, 206-4 for the illustrated second set of transducers 402-1, 402-2, 402-3, 402-4 are positioned at 90 degree intervals 328 around the vertical axis 224 of the sonic head 114.

FIG. 3 also illustrates a representative dispersion pattern of the emitted ultrasonic waves 304-1, 314-A1 relative to the sonic head 114. The ultrasonic waves 304-1, 314-A1 have the shape of a truncated or reduced circular cone where the axis of the cone coincides with the transducer axis 206-1, 214-A1. The cut-off vertex of the truncated cone-shaped wave 304-1, 314-A1 coincides with the radiating surface 324, 322 proximate the transducer 402-1, 714-A that emits the ultrasonic wave 304-1, 314-A1. The sides of the cone-shaped wave 304-1, 314-A1 define an angle 302-1, 302-A1 corresponding to the dispersion of the ultrasonic wave 304-1, 314-A1 away from the sonic head 114. The angular offset 326, 328 between the axis 206, 214 of the emitted ultrasonic waves 304, 314 is selected to minimize interference between adjacent ultrasonic waves 304, 314. That is, the ultrasonic waves 304, 314 do not travel the same path, which reduces the effects of canceling or colliding between the ultrasonic waves 304, 314. That is, in the illustrated embodiment, each the ultrasonic wave 304, 314 subtends an angle 302 at least one half of the angular offset 326, 328 between the axis 206, 214 of the emitted ultrasonic waves 304, 314. Generally, the strength of the ultrasonic wave 304, 314 decreases as the wave 304, 316 disperses from its corresponding axis 206, 214. With each ultrasonic wave 304, 314 subtending an angle 302 greater than one half of the angular offset 326, 328 between the axis 206, 214 of the emitted ultrasonic waves 304, 314, then 360 degree horizontal coverage from each set of transducers 714, 402 is ensured.

With respect to the first set of transducers 714, the axes 214 are distributed such that the emitted ultrasonic waves 314 provide 360 degree coverage around the vertical axis 224 of the sonic head 114. In the illustrated embodiment, the axes 214-A, 214-B passing through the upper and lower transducer housings 204-A, 204-B are not co-planar, but they pass through the vertical axis 224 of the sonic head 114 such that, when viewed from above as illustrated in FIGS. 3 & 4, the axes 214-A, 214-B intersect at right angles, thereby ensuring that the emitted ultrasonic waves 314 associated with each axes 214 provide 360 degree coverage around the vertical axis 224 of the sonic head 114 when the angle 302-A1 of the waves 314-A1 is equal to or greater than 90 degrees.

With respect to the second set of transducers 402, a plane defined by the coplanar axes 206 is substantially parallel with the surface 104 of the water 102. The four axes 206 extending away from the second set of transducers 402 are distributed at 90 degrees 328 from the center of the sonic head 114. When the angle 302 associated with each axis 206 is greater than or equal to 90 degrees, then ultrasonic waves 304 are distributed for a full 360 degrees of coverage around the vertical axis 224 of the sonic head 114 within the defined plane.

FIG. 4 illustrates the inside of the housing 216 that encloses a circuit board 410 and the second set of transducers 402. The circuit board 410 includes the electrical circuitry that drives the various transducers 402, 714. FIG. 4 illustrates the electrical wiring 412 between each piezoelectric element 404 and the circuit board 410. For example, in the illustrated embodiment of the transducer 402 with the block 406, one electrical wire 412-B is electrically and mechanically connected to the block 406, with one surface of the block 406 in electrical connection with the piezoelectric element 404. The other electrical connection to the piezoelectric element 404 is with the wire 412-A in electrical connection with the face of the piezoelectric element 404 that is adjacent the inside surface 216i of one of the faces 502 of the housing 216. In another embodiment, the second set of transducers 402 includes two groups of four transducers 402 in each group. In such an embodiment, the second group of transducers 402 are positioned against the inside surface 216i on the walls between the transducers 402-1, 402-2, 402-3, 402-4 of the first group.

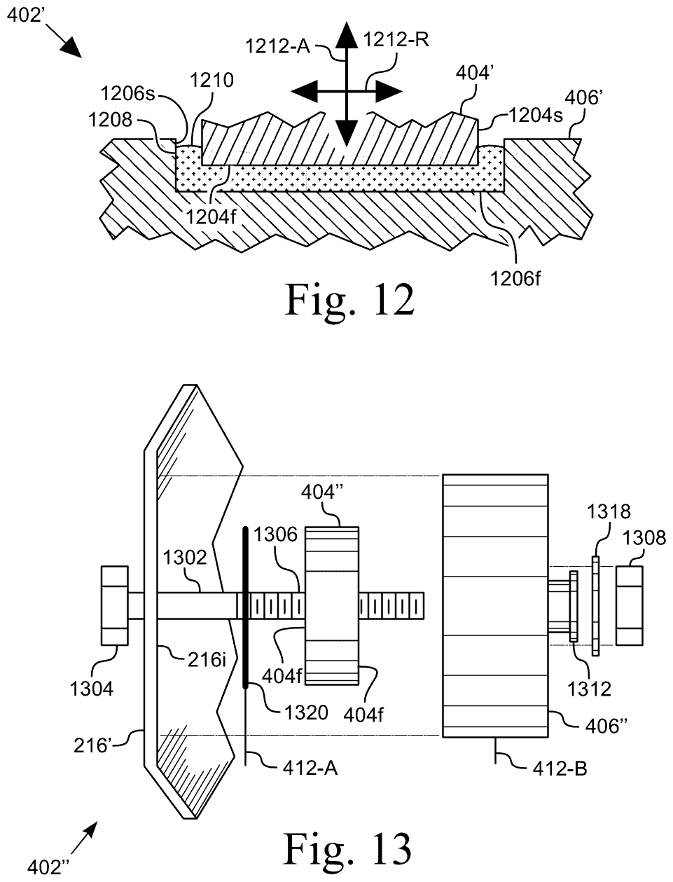

The illustrated embodiment of the transducers 402-1, 402-2, 402-3, 402-4 illustrate that each transducer 402 includes a piezoelectric element or crystal 404 and a block 406. The illustrated crystal 404 is sandwiched between the housing 216 and the block 406 with the crystal 404. In one such embodiment, the crystal 404 is adhered to the inside surface of the housing 216 and to the block 406 with an adhesive, such as the adhesive 1210 illustrated in FIG. 12.

In the illustrated embodiment, the housing 216 includes a feedback sensor 436 connected to the circuit board 410. The feedback sensor 436 is responsive to the ultrasonic waves 314, 304 emitted by the various transducers 714, 402. In one embodiment, the feedback sensor 436 is responsive to the pressure of the ultrasonic waves 314, 304 generated by the transducers 714, 402. If a transducer 714, 402 fails, either electrically or mechanically, such as by failure of the attachment to the housing 216, the feedback sensor 436 detects the reduction in the intensity of the ultrasonic waves 314, 304. The reduction in detected intensity is generally a step reduction, for example, when one of the four transducers in the second set of transducers 402 fails, there is potentially a 25% reduction in intensity at the frequency emitted by those transducers 402.

In the illustrated embodiment, the feedback sensor 436 is positioned inside the housing 216 away from the inside surface 216i. In such an embodiment, the inside of the housing 216 is filled with a waterproof potting compound that acoustically couples the feedback sensor 436 to the housing 216. In another embodiment, the feedback sensor 436 is attached to the housing 216 with an acoustic coupling, thereby ensuring the feedback sensor 436 is responsive to the ultrasonic waves 314, 304. In such an embodiment, the feedback sensor 436 is attached either to the inside or the outside of the housing 216.

In the illustrated embodiment, a connector 426 is attached to and penetrates a wall of the second housing 216. The connector 426 is electrically connected and configured to mate with the end connector 226 of the cable 126. In another embodiment, the connector 426 is attached to and penetrates either the top or bottom wall of the housing 216.

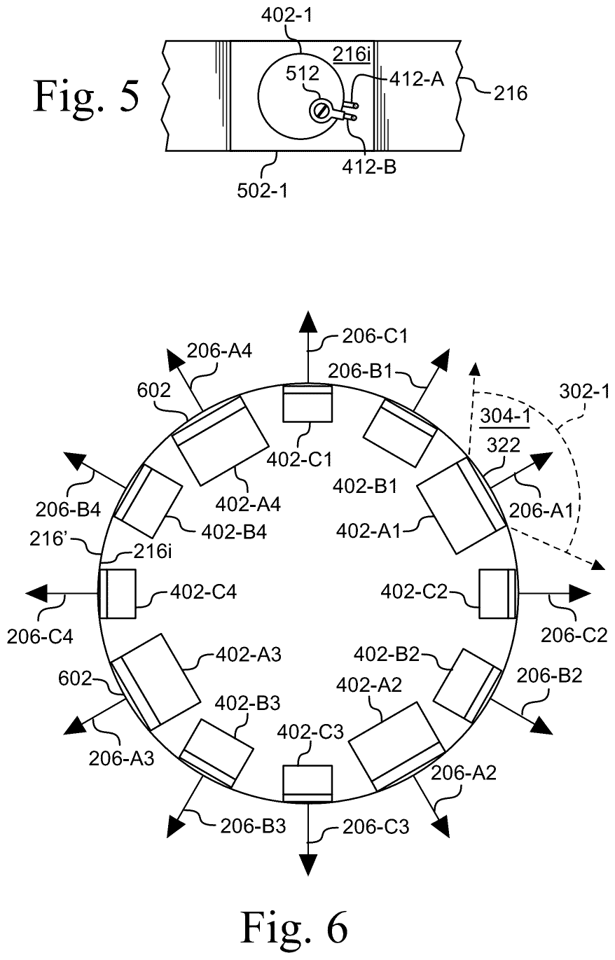

FIG. 5 illustrates a cross-sectional view of one embodiment of the inside of the driver housing 216 shown in FIG. 3. In the illustrated embodiment, each one of the second set of transducers 402 include a piezoelectric element 404 with a block 406. The block 406 is attached to an inboard surface of the piezoelectric element 404. The outboard surface of the piezoelectric element 404 is coupled to an inside surface 216i of one of the faces 502 of the housing 216. In this way, the piezoelectric element 404 of the transducer 402-1 emits ultrasonic waves 304 through the face 502-1 of the housing 216 and into the surrounding water 102. For the embodiment with the blocks 406, the block 406 aids in forcing the ultrasonic waves 304 to be emitted from the outboard surface of the piezoelectric element 404. In another embodiment, each transducer 402 includes only the piezoelectric element 404 without the block 406.

In the illustrated embodiment, one of the two wires 412-B is connected to the block 406 with a ring terminal 512 secured with a screw. The other wire 412-A is electrically bonded to a face of the piezoelectric element 404.

FIG. 6 illustrates a partial cross-sectional view of another embodiment of the driver housing 216′ showing three groups 402-A, 402-B, 402-C of the second set of transducers 402. In the illustrated embodiment, the second housing 216′ is cylindrical with each transducer 402 secured to the inside surface 216i with an adhesive 602 that acoustically couples the transducer 402 to the housing 216′ such that an ultrasonic wave 304 is emitted from the radiating surface 322 that is opposite the transducer 402. In the illustrated embodiment, the adhesive 602 fills the void between the transducer 402 and the inside surface 216i. In another embodiment, the housing 216′ is a polygon with a sufficient number of walls such that each transducer 402 is attached to one wall. In another embodiment, each transducer 402 is secured to the housing 216 by way of a fastener.

In various embodiments, the second set of transducers 402 include one or more groups of transducers. The illustrated embodiment shows that the second set of transducers 402 include three groups of transducers 402-A, 402-B, 402-C. Each transducer 402 in a group 402-A, 402-B, 402-C is disposed 90 degrees from the adjacent ones of the transducers 402 in the group 402-A, 402-B, 402-C. Each transducer 402 has an axis 206 corresponding to the center of the ultrasonic wave 304 emitted by that transducer 402. In the illustrated embodiment, the transducers 402 are positioned on a plane with the adjacent axes 206-A, 206-B, 206-C spaced 30 degrees apart. In another embodiment, the transducers 402 are positioned such that the transducers in the first group 402-A are non-planar with the second group 402-B, which are non-planar with the third group 402-C. In one such embodiment, the three groups 402-A, 402-B, 402-C are aligned vertically, such as with the housing 216 shown in FIG. 4.

In the illustrated embodiment, each group 402-A, 402-B, 402-C is configured for a specific frequency range. For example, the first group 402-A has large transducers 402-A1, 402-A2, 402-A3, 402-A4 that are optimized to operate with a specific frequency range. The second group 402-B has transducers 402-B1, 402-B2, 402-B3, 402-B4 that are smaller than the first group 402-A and are optimized to operate with a specific frequency range higher than the first group 402-A. The third group 402-C has transducers 402-C1, 402-C2, 402-C3, 402-C4 that are smaller than the first and second groups 402-A, 402-B and are optimized to operate with a specific frequency range higher than the first and second groups 402-A, 402-B. For example, the first group 402-A has an operating range of 400 kHz to 600 kHz, the second group 402-B has an operating range of 900 kHz to 1,100 kHz, and the third group 402-C has an operating range of 1,500 kHz to 2,000 kHz. A person skilled in the art will recognize that the specific operating range of each group varies based on the micro-organisms being targeted without departing from the spirit and scope of the present invention.

Each group of the second set of transducers 402 is operable simultaneously with each group operating at a different frequency. In this way, interference between the groups of transducers 402 is minimized while decreasing the time for the second set of transducers 402 to sweep through the full range of frequencies. In one embodiment, each group of transducers 402 has staggered on or energized times such that only one group of transducers 402 is on or energized at a time.

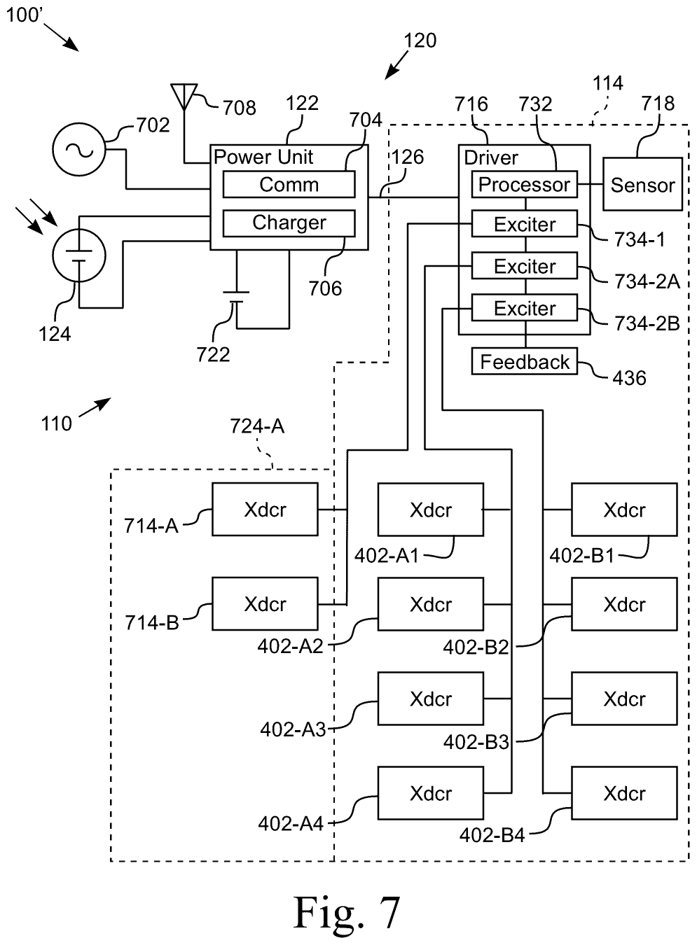

FIG. 7 illustrates a block diagram of one embodiment of the algae control system 100′ that includes two groups 402-A, 402-B of the second set of transducers 402. The illustrated embodiment of the power supply unit 120 shows multiple power sources 124, 702, 722. The power sources include a mains supply 702, a solar panel 124, and a battery 722, all connected to the power unit 122. The mains supply 702 is an external power supply, such as a 120 Vac or 240 Vac mains connection. The solar panel 124 is an array of photovoltaic modules of solar cells. The solar panel 124 is connected to a battery charger 706 in the power unit 122 that charges a battery 722. The battery 722 is a pack of cells for storing the energy accumulated from the solar panel 124. The battery 722 is also charged by the mains supply 702, if there is one. For one embodiment of the power supply unit 120 having the mains supply 702, the solar panel 124, and the battery 722, the power supply unit 120 is operable as an uninterruptable power supply. In other embodiment the power supply unit 120 includes either a mains supply 702 or a solar panel 124 and a battery 722. In an embodiment of the power supply unit 120 having a battery 722, the power unit 122 includes a load monitor that shuts down the power unit 122 when the battery 722 nears depletion. In this way the battery 722 is protected from being totally discharged and thereby damaged.

The power unit 122 converts the power provided by the power sources 124, 702, 722 to a voltage level needed to power the sonic head 114. For example, the power unit 122 converts the 120 Vac mains power and/or the 24 Vdc battery power to the 40 Vdc operating voltage required by one embodiment of a sonic head 114. In various embodiments, one function of the power unit 120 includes selection of input power, such as between the mains supply 702, the battery 722, or the solar panel 124. Another function is controlling the power supplied to the transducer unit 110, such as by adjusting the output voltage in response to a command from the sonic head 114 because the sonic head 114, for the embodiment shown in FIG.1, is some distance, such as hundreds or thousands of meters, away from the power unit 120 via a cable 126. In such a case, the supply voltage is increased to compensate for any voltage drop across the cable 126. In one embodiment, the schedule includes time of day on/off periods thereby preventing certain aquatic life from feeding when the sonic head 114 is on or energized and allowing certain aquatic life to feed with the sonic head 114 off or de-energized. When the sonic head 114 is on or energized, the sonic head 114 is emitting ultrasonic waves. When the sonic head 114 is off or de-energized the sonic head 114 is not emitting ultrasonic waves.

The power unit 122 includes a communication module 704 that enables communication with a remote computer or other device. The communication module 704 has an antenna 708 for wireless communications. In another embodiment the communication module 704 includes a port allowing a local device to be connected to the module 704. An example of such a port is a universal serial bus (USB) connector. The communication module 704 is also connected to the cable 126, which includes data conductors. In one embodiment the communications module 704 includes a UART (universal asynchronous receiver/transmitter (UART) that communicates with the processor 732. New programming of the processor 732 is downloadable either from a remote location or by way of a local connection.

The power unit 122 is connected to the transducer unit 110 by a cable 126. The cable 126 carries power and the control signals required by the transducer unit 110. The cable 126, in one embodiment, include separate conductors 126-pwr, 126-comm for the power and the control signals. In another embodiment, the cable 126 includes power conductors 126-pwr that also carry the bidirectional control signals.

The transducer unit 110 includes a sonic head 114 that has a driver 716, a sensor 718, a subassembly 724-A of the first set of transducers 714, and the second set of transducers 402. The cable 126 supplies power to the driver 716 and also carries communication signals between the power unit 120 and the sonic head 114. In one embodiment, the communication signals are carried by conductors separate from the power carrying conductors in the cable 126. In another embodiment, the communication signals are carried by the power conductors, thereby eliminating the need for additional conductors in the cable 126.

In the illustrated embodiment, a sensor 718 is included with the sonic head 114 for sensing or measuring one or more characteristics associated with the algae control system 100. For example, in one embodiment, the sensor 718 samples the water 102 to determine the presence and/or concentrations of various microorganisms of interest. In one embodiment the sensor 718 includes a pump that draws in water 102 for a sample, tests the sample, determines the characteristics of the sample, and communicates the test results to the processor 732 in the driver 716. The processor 732 communicates with the communication module 704 in the power unit 122. The communication module 704 then communicates with a remote user, who determines the operating parameters of the sonic head 114 based on the results provided by the sensor 718. The remote user sends those operating parameters to the power unit 122, where the received data is then communicated to the processor 732 in the driver 716. The processor 732 then controls the exciter 734 to cause the transducers 714 to operate with the determined operating parameters.

The illustrated embodiment of the transducer subassembly 724-A includes the first set of transducers 714-A, 714-B that provide 360 degree coverage horizontally around the sonic head 114. The first set of transducers 714-A, 714-B operate at frequencies, in one embodiment, between 22 kHz and 720 kHz. Each one of the first set of transducers 714-A, 714-B is oriented to project waves 314 90 degrees, or normal, to the other, thereby providing substantially full, 360 degree coverage in a horizontal plane when deployed in the body of water 102.

The illustrated embodiment shows two groups of the second set of transducers 402-A1, 402-A2, 402-A3, 402-A4, 402-B1, 402-B2, 402-B3, 402-B4 that provide 360 degree coverage horizontally around the sonic head 114. The two groups of the second set of transducers 402-A, 402-B operate at frequencies between 500 kHz and 1500 kHz. Each one of the second set of transducers 402-1, 402-2, 402-3, 402-4 in each group 402-A, 402-B is oriented to project waves 304 90 degrees, or normal, to the other, thereby providing substantially full, 360 degree coverage in a horizontal plane when deployed in the body of water 102.

The driver 716 is an electrical circuit connected to the transducers 402, 714. In one embodiment, the driver 116 operates each transducer 402, 714 with a pre-defined duty cycle. In one such embodiment, each transducer 402, 714 has a duty cycle with an on-cycle of 0.4 seconds and an off-cycle of 0.6 seconds for a period of 1 second. In one embodiment, the transducers 402, 714 are operated simultaneously. In another embodiment, the transducers 402, 714 are operated alternatingly, for example, one transducer 714-A emits opposing waves 314 for at least 180 degree coverage, with the other transducer 714-B, when energized, emitting opposing waves 314 for at least 180 degree coverage that is offset from the first transducer 714-A. In this way full 360 degree coverage is provided by the first set of transducers 714-A, 714-B.

In the illustrated embodiment, the driver 716 includes three exciters 734-1, 734-2, 734-3, each connected to one set or group of transducers 714, 402-A, 402-B. The exciters 734 in the driver 716 cause the transducers 402, 714 to be driven at various frequencies conducive to targeting specific microorganisms, such as dinoflagellate, green algae, and blue-green algae. In one embodiment, each exciter 734 includes a PWM circuit that energizes the connected transducers 402, 714 at a frequency and with a duty cycle controlled by the processor 732. In one embodiment the transducers 402, 714 are operated with an on/off duty cycle that pulses the frequencies across a wide frequency range. For example, the first set of transducers 714 are operated with a first frequency in the range between 24 and 58 kHz and a second frequency in the range between 195 and 205 kHz. The lower frequency range targets green algae and diatom algae. The upper frequency range targets blue-green algae with gas vesicles.

The processor, or microcontroller, 732 is programmed to drive the transducers 402, 714 in a specified manner. In various embodiments, the programming of the processor 732 controls the following driver variables, or operating parameters: the frequency range and bandwidth, the time on/off at each discrete frequency, the step change from one frequency to the next, and the power setting per frequency. These variables are determined based on the microorganisms to be targeted, the size of the body of water, and the information, such temperature, pressure, light, and g-force, provided by any of various sensors 718. In one embodiment, the sensor 718 determines the presence and/or concentration of specific microorganisms. This information is sent from the sensor 718, to the processor 732, to the communications unit 704 to a remote location, where the driver variables are determined. After the driver variables are determined, they are sent to the communications module 704, through the cable 126 to the processor 732, which then operates the transducers 402, 714 in accordance with the driver variables.

The frequency range and bandwidth is adjustable. For example, in one embodiment the frequency for the first set of transducers 714 is adjustable between 10 kHz and 20 kHz in 10 Hz increments. In such an example, the processor 732 is configured to cause the transducers 714-A, 714-B to emit at one or multiple frequencies. The processor 732 also controls the power or voltage setting for each frequency emitted. In this way the dB level is controlled. For example, higher frequencies requires more energy (higher voltages) in order to maintain a constant dB level of the emitted sonic wave. The size of the body of water 102 determines the power level required to effectively cover the body of water 102. The schedule of time on and off is determined to accommodate particular environments. For example, catfish may not feed when the transducers 402, 714 are operating or energized. A feed schedule is determined to allow the catfish, or other aquatic life, to feed with the transducers 402, 714 turned off or de-energized.

Other variables of concern include water temperature and pressure and light. The sensor 718, in one embodiment, measures the temperature of the water 102, the depth of the sonic head 114 and/or light around the system 100. In one embodiment, the processor 732 is programmed to adjust the driver variables based on the temperature, pressure, and light variables.

In another embodiment, the sensor 718 includes a humidity or moisture sensor responsive to the inside of the driver housing 216. Upon sensing a high humidity or moisture level, the processor 732 sends a water leak detected signal to the communications module 704, where a water leak detected alarm is given.

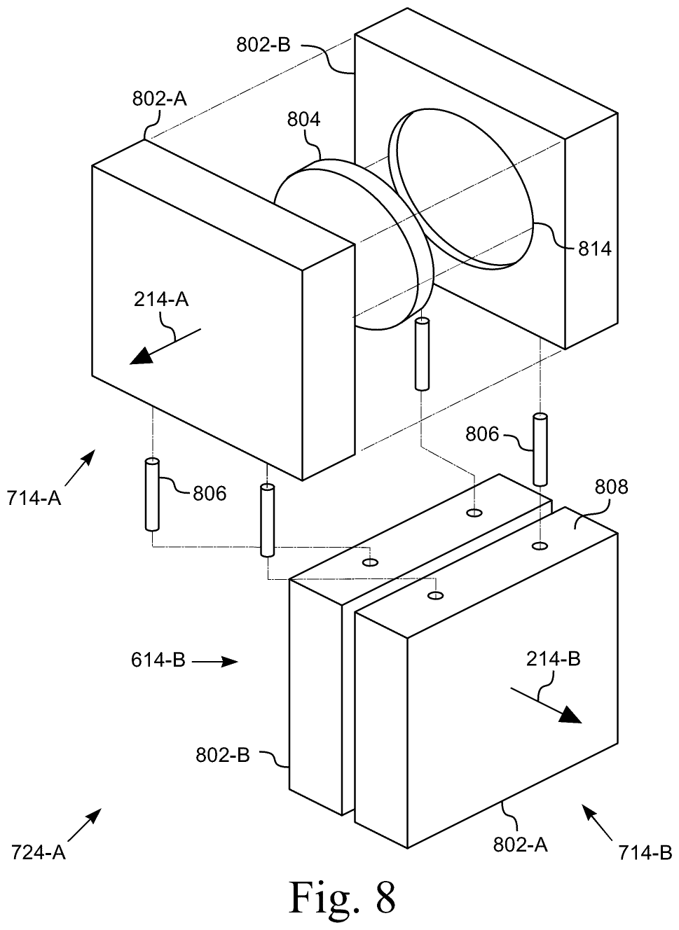

FIG. 8 illustrates an exploded view diagram showing one embodiment of a transducer subassembly 724-A for the first set of transducers 714-A, 714-B. The transducer subassembly 724-A includes a first transducer 714-A and a second transducer 714-B that are connected, in the illustrated embodiment, with isolators 806. The isolators 806 provide isolation of the vibrations from each transducer 714-A, 714-B from the other transducer 714-B, 714-A. The pins 806 fit into corresponding holes 808 in the blocks 802, thereby aligning and securing each pair of blocks 802-A, 802-B at right angles to each other while providing vibration isolation between the blocks 802-A, 802-B of the two transducers 714-A, 714-B. The isolators 806 have a length sufficient for the second housing 216 to fit between each transducer 714-A, 714-B

Each transducer 714 includes a pair of blocks 802 with an element 804 sandwiched therebetween. The element 804 is a piezoelectric crystal that vibrates when electric energy is applied to it. The blocks 802-A, 802-B are metal, such as aluminum or other metal that is conductive to vibratory frequencies originating from the element 804. The blocks 802-A, 802-B each have a recess 814 sized to receive the piezoelectric element 804. In one embodiment the piezoelectric element 804 is a crystal with electrodes on opposite sides. The electrodes extending from the piezoelectric element 804 are electrically connected to the driver 716. The blocks 802 have a mechanical connection with the sides of the element 804 and provide a large, flat surface for emitting ultrasonic waves. In one embodiment each element 804 is electrically bonded to each block 802-A, 802-B by a conductive adhesive on each face of the element 804. In this way the blocks 802 conduct the electrical energy from the driver 716 to the element 804, which then produces a vibratory frequency.

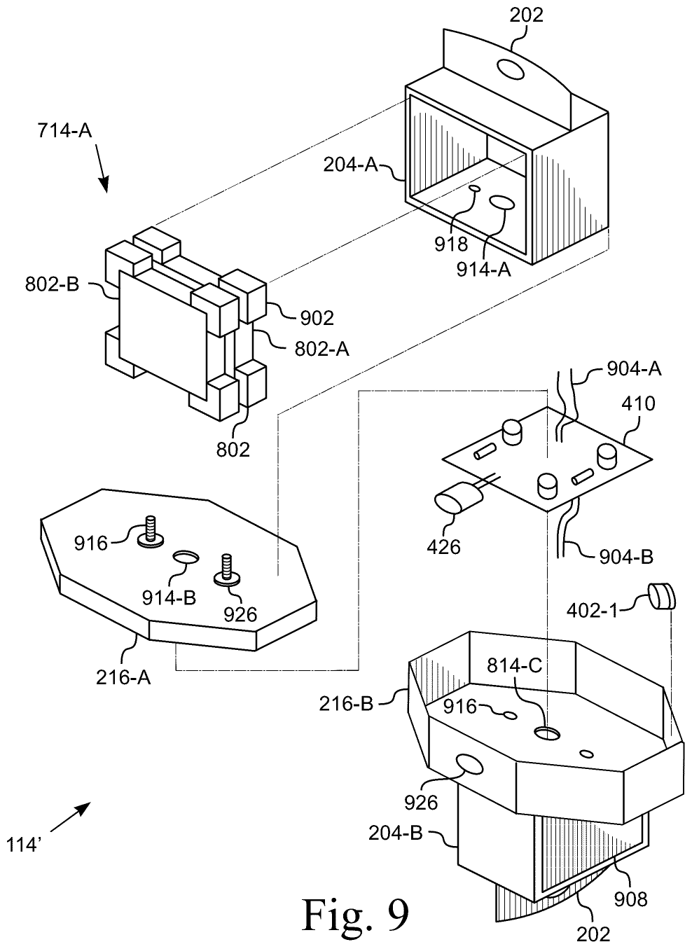

FIG. 9 illustrates an exploded diagram showing another embodiment of a sonic head 114′. The upper transducer housing 204-A is shown separated from the upper half 216-A of the driver housing 216, one transducer 714-A is shown separated from the upper housing 204-A, and one second transducer 402-1 is shown separated from the lower half 216-B of the driver housing 216.

The illustrated embodiment of the first transducer 714-A has corner spacers 902 at each corner of each block 802-A, 802-B of the transducer 714-A. The upper housing 204-A has four walls defining four inside surfaces. In other embodiments, the housing 204 has a box-type configuration with walls enclosing the transducer 714 on five or six sides. The transducer 714-A has a sliding fit inside the upper housing 204-A with the corner spacers 902 filling the space between the blocks 802 and the inside of the housing 204-A. The remainder of the space between the transducer 714-A and the housing 204-A is filled with a potting compound 908 or other waterproof filler such that the transducer 714-A is fully encapsulated inside the housing 204-A. In this way the transducer 714-A is protected from direct contact with the water 102 and the absence of air voids and pockets ensures the transmission of the sonic waves from the piezoelectric element 804 to the outside of the housing 714-A. The potting compound 908 fills the inside of the transducer housing 204-A flush with the edges of the open sides. The potting compound 908 has a density substantially the same as the water 102, thereby the ultrasonic waves emitted by the element 804 are conducted through the blocks 802, through the potting compound 908 and into the water 102 without being refracted or attenuated.

The illustrated embodiment of the driver housing 216 is illustrated in two parts: an upper driver housing 216-A and a lower driver housing 216-B that engages the upper housing 216-A. Inside the driver housing 216 is a cavity that receives the driver 716, which is illustrated as a circuit board 410 with a connector 426 configured to receive a connector at the end of the cable 126. The driver connector 426 mates with the cable connector 226 with a waterproof mechanical connection. The connector 426 on the driver 716 aligns with the opening 926 in the lower driver housing 216-B. In another embodiment of the sonic head 114, the driver connector 426 is positioned under the circuit board 410 and engages the cable connector 226 at the bottom of the lower driver housing 216-B.

The housing 204-A has a first opening 914-A that is coincident with a corresponding opening 914-B in the upper driver housing 216-A. The upper driver housing 216-A includes openings through which fasteners 916 protrude. Between the outer surface of the upper driver housing 216-A and the lower, outer surface of the upper housing 204-A is an opening 926 for the connector 426. Each fastener 916 engages one of a pair of threaded openings 918 in the upper transducer housing 204-A, thereby securing the upper transducer housing 204-A to the upper driver housing 216-A.

The driver 716 includes a pair of conductors 904-A that pass through the opening 914 in the upper driver housing 216-A and make electrical connection to the piezoelectric element 804 in the transducer 714-A. The driver 716 also includes a pair of conductors 904-B that pass through the opening 914-C in the lower driver housing 216-B and make electrical connection to the piezoelectric element 804 in the transducer 714-B. In one embodiment the conductors 904 make electrical contact with blocks 802, which are themselves electrically connected to the element 804. In one embodiment, the driver housing 216 is a waterproof enclosure. In another embodiment, the cavity in the driver housing 216 is filled with a potting compound 908 or other waterproof filler.

Below the driver housing 216 is the lower transducer housing 216-B, which includes a lower transducer 714-B that is configured similarly to the upper transducer 714-A. The upper housing 216-A and upper transducer 714-A are oriented at a horizontal 90 degree angle relative to the lower housing 216-B and lower transducer 714-B. The axes of the emitted ultrasonic waves are normal or perpendicular to each other and oriented horizontally when the sonic head 114′ is in the deployed position.

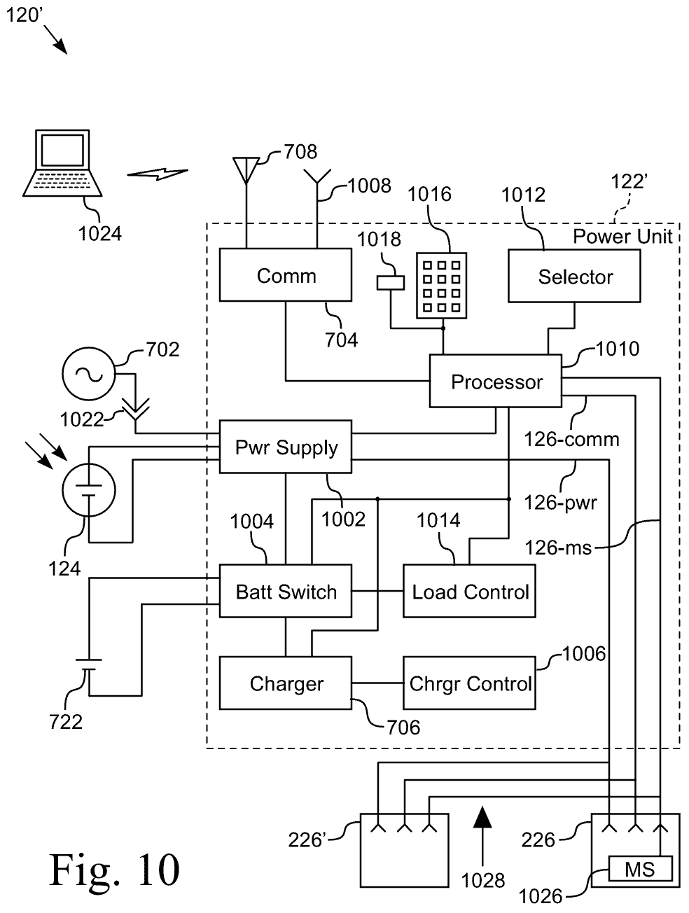

FIG. 10 illustrates a block diagram of one embodiment of a power supply unit 120′. The illustrated embodiment of the power supply unit 120′ includes a connection 1022 to a mains supply 702, a photovoltaic panel 124, a battery 722, and a power unit 122′. The power unit 122′ includes a communications module 704 connected to a processor 1010, a power supply 1002 connected to a switch 1004 and the processor 1010, a load control 1014 connected to the switch 1004 and the processor 1010, and a charger 706 connected to the switch 1004 and a charger control 1006.

The communications module 704 is connected to a wireless antenna 708 and an external device connector 1008. A remote device 1024, such as a laptop or other computing device, is in wireless communication with the antenna 708. In various embodiments the wireless communication is by way of Bluetooth, WiFi, MiFi, or other forms of wireless communication. In another embodiment the remote device 1024 electrically plugs into the connector 1008 for a direct electrical connection to the communications module 704.

The processor 1010 is connected to input/output (I/O) devices such as a keyboard 1016, a display unit 1018, and an application configuration selector switch 1012. In various embodiments, the keyboard 1016 provides for direct alpha-numeric input to the processor 1010, as well as menu selection. In various embodiments, the display unit 1018 provides alpha-numeric output and status indication. For example, the display unit 1018 works in conjunction with the keyboard 1016 for entry of alpha-numeric data and menu selection. The display unit 1018, in another embodiment, includes indicator lights providing status information. For example, for embodiments in which the processor 1010 is connected to the charger 706, the display unit 1018 shows the charge state and status of the battery 722 as a colored or blinking light or as an alpha-numeric display.

The processor 1010 is connected to the other components in the power unit 122′, such as the power supply 1002, the battery switch 1004, the battery charger 706, and the load control 1014. In this way the processor 1010 monitors and controls the power unit 122′. The processor 1010 has an I/O link to the sonic head 114′ though the cable 126-comm. In the illustrated embodiment, the cable 126 has multiple conductors with at least a pair of conductors 126-pwr dedicated to providing power and at least one other conductor 126-comm providing a communication connection with the sonic head 114′. In another embodiment, the power conductors 126-pwr also carry the control and communication signals instead of the signals being conducted along separate, isolated conductors 126-comm. In the illustrated embodiment, the end connector 226 attached to the cable 126 includes a moisture sensor MS 1026 that is connected to the processor 1010 by way of electrical pathway 126-ms in the cable 126. The moisture sensor 1026 is responsive to water and/or moisture in the volume where the end connector 226 is mated with the housing connector 426. The moisture detector 1026 detects the failure of the connection of the end connector 226 and the housing connector 426 where the failure allows water intrusion into the connectors 226, 426.

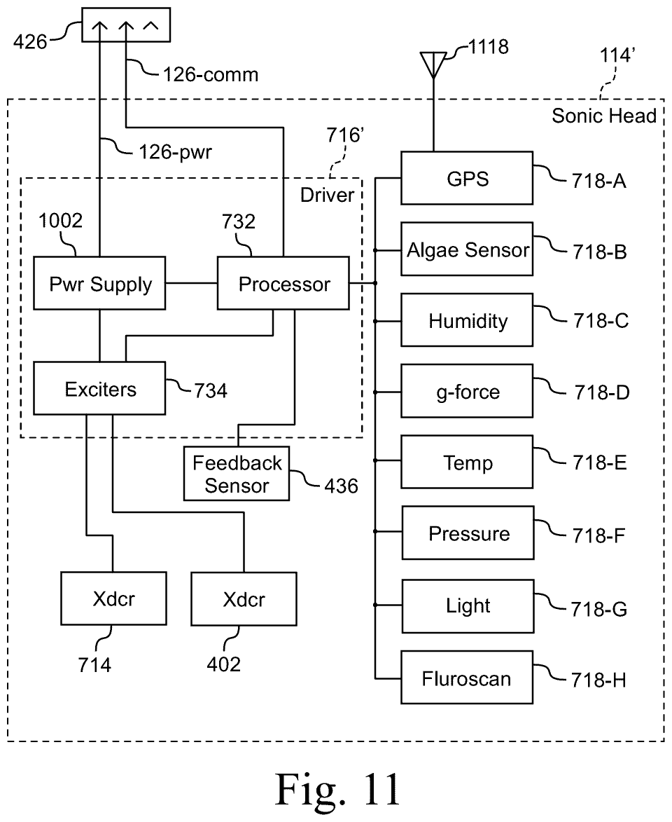

In the illustrated embodiment, a cable 126-comm includes an extension 1028 that connects a first end connector 226 to a second end connector 226′. The connectors 226, 226′ are each configured to mate to the connector 426 of a sonic head 114′ such as illustrated in FIG. 11. The extension 1028 has a length equal to the desired depth separation of the two sonic heads 114′. In this way, each sonic head 114′ provides algae control at a depth separated by the length of the extension 1028 and the length of the anchor line 132 extending between the two sonic heads 114′. In another embodiment, a string of extensions 1028 and connectors 226′ are provided to allow connection of multiple sonic heads 114′.

In the embodiment with multiple sonic heads 114′, the cable 126-comm caries a signal that allows parallel operation of multiple devices, such as multiple sonic heads 114′ wired in parallel. One such signal protocol of the cable 126-comm is I2C, which is a synchronous, multi-slave serial communication bus. Another such signal protocol of the cable 126-comm is RS485, which is a multiple device serial interface bus.

FIGS. 7, 10, and 11 are block diagrams that show functional features and interconnections therebetween. The figures are not schematics nor wiring diagrams showing individual conductive paths. For example, the connector 226 shows three connections between the power unit 122′ and the end connector 226. Those skilled in the art will recognize that each pathway 126-comm, 126-pwr, 126-ms includes one or more conductors as needed to implement the invention. In one embodiment as noted above, the pathway 126-pwr includes two conductors for power between the power supply 1002 and the end connector 226 and the pathway 126-comm includes one or more conductors for carrying signals between the processor 1010 and the end connector 226. Likewise, extension cable 1028 includes three or more conductors between the first end connector 226 and the second end connector 226′.

The application configuration selector switch 1012 provides for manual selection of a set of pre-defined operating parameters for the sonic head 114′. An application configuration is a set of operating parameters for a specific set of conditions. For example, one application configuration defines the frequency range and bandwidth, the time on/off at each discrete frequency, the step change from one frequency to the next, and the power setting per frequency in order to target specific microorganisms in a specific type and size of body of water 102. The selection of an application configuration allows the algae control system 100 to operate in a pre-defined manner. In one embodiment, the selector switch 1012 is a multi-gang DIP switch in which the digital number corresponding to a pre-defined configuration is selected by operating the individual switches.

The power supply 1002 converts the voltage level of the input power sources to a transmission voltage level sent over cable 126-pwr. In one embodiment, the power supply 1002 has an output of 40 Vdc that is sent to a power supply 1102 in the sonic head 114′. The power supply 1002, in various embodiments, has multiple inputs. The battery 722 is connected to a battery switch 1004 that selectively connects the battery 722 to the power supply 1002 as a power source or to the battery charger 706 for charging the battery 722. In another embodiment the battery 722 is connected directly to the battery charger 706, which functions to both charge the battery 722 and provide battery power to the power supply 1002.

The battery charger 706 is powered by the power supply 1002, which has a power source of either the power mains 702 or a solar panel 124. In one embodiment, a charger control 1006 controls the battery charger 706. The charger control 1006 is a switch that selects the battery type to be charged.

The power unit 122′ in one embodiment includes a load control 1014 that monitors the current state of charge of the battery 722 and isolates the battery 722 to prevent total discharge. For example, when the load control 1014 determines that the battery 722 is within 10% of being fully discharged, the load control 1014 operates the switch 1004 to isolate the battery 722 from the power supply 1002 and connect the battery 722 to the battery charger 706.

FIG. 11 illustrates a block diagram of one embodiment of a sonic head 114′. The sonic head 114′ includes a driver 716′, a first set of transducers 714, a second set of transducers 402, and various sensors 718-A to 718-H. In one embodiment, the first set of transducers 714 include a pair of transducers 714-A, 714-B. In another embodiment, the first set of transducers 714 includes a single transducer 714-C. In various embodiments, the second set of transducers 402 include one or more groups 402-A, 402-B, 402-C of transducers.

The sonic head 114′ is electrically connected to the power supply unit 120′ through the communications conductors 126-comm and the power conductors 126-pwr of the cable 126. The connector 426 mates with the end connector 226 on the cable 126.

The driver 716′ includes a power supply 1002, a processor 732, and one or more exciters 734. The power supply 1102 in the drive 716′ is connected to the power supply 1002 in the power unit 122′ through the power conductors 126-pwr. The power supply 1102 ensures that the proper power and voltage levels are maintained in the driver 716′ regardless of the length of the cable 126 and any voltage drop in that cable 126. In one embodiment, the exciters 734 includes a circuit connected to one or more of the transducers 714, 402. In other embodiments, the exciters 734 include multiple circuits each connected to one or more of the transducers 714, 402 such that each transducer 714, 402 or set or group of transducers are individually excited. The exciters 734 are controlled and switched by the processor 732 so as to cause the various transducers 714, 402 to operate at a desired frequency with a desired duty cycle.

In the illustrated embodiment, the feedback sensor 436 is connected to the processor 732. The feedback sensor 436 monitors the performance of the various transducers 714, 402 in the sonic head 114′. In this way, if any transducer 714, 402 fails, the processor 732 initiates a predetermined action, such as a notification or providing indication that the system 100 has failed or is not performing satisfactorily. In one such embodiment, the failure detected by the feedback sensor 436 is logged.

The processor 732 in the driver 716′ is connected to the processor 1010 in the power unit 122′ through the communication conductors 126-comm. In various embodiments, the two processors 1010, 732 communicate via either a synchronous or an asynchronous serial connection. The processor 732 is also connected to the power supply 1102, the exciter 734, and one or more sensors 718-A to 718-H. The number and combination of sensors varies based on the particular configuration desired for the algae control system 100. In one embodiment, the sensors 718-A to 718-H have outputs that are processed directly by the driver processor 732 with resulting pertinent information communicated to the power unit processor 1010. In another embodiment, the sensors 718-A to 718-H have outputs that are transmitted to the power unit processor 1010, where the outputs are processed directly.

One sensor 718-A is a GPS unit with an antenna 1118 mounted above the surface 104 of the water 102. In another embodiment, the entire GPS unit 718-A is located above the surface 104 of the water 102. The GPS unit 718-A is a Global Positioning System transceiver that provides location information to the processors 732, 1010. With this information, the processors 732, 1010 are able to determine if the transducer unit 110′ has moved, such as by drifting or even by being stolen. Further, the processors 732, 1010 are able to report on the current location of the transducer unit 110′ for inventory control purposes.

Another sensor 718-B is an algae sensor that is responsive to the presence and/or concentration of various microorganisms in the surrounding water 102. For example, the algae sensor 718-B measures turbidity, which may be related to or correlates to the quantity of microorganisms in the water 120. With this information, the processors 732, 1010 are able to determine the presence and/or concentration of the specific microorganisms desired to be targeted and adjust the operating parameters to target those detected microorganisms. For example, when green algae is detected, the processors 732, 1010 control the sonic head 114 to emit ultrasonic waves with a frequency and/or duty cycle targeting the algae.

Another sensor 718-C is a humidity or moisture sensor that is responsive to the environment inside the driver housing 216. The humidity sensor 718-C has an output used by the processors 732, 1010 to determine if a leak is present in the sonic head 114′. If a leak is detected by the humidity sensor 718-C, the power unit processor 1010 communicates that information to a remote device 1024 and/or indicates that information on the local display 1018.

Another sensor 718-D is a g-force sensor that is responsive to movement of the sonic head 114′. In one embodiment the g-force sensor 718-D is an accelerometer with an output that varies based on the motions of the sensor 718-D in the sonic head 114′. For example, extreme wave motions in the body of water 102 indicate that the water is in motion, and that information is useful for determining the frequency and power output for the transducers 714. The output of the g-force sensor 718-D is used by the processors 732, 1010 to determine an optimum application configuration or set of operating variables.

Another sensor 718-E is a temperature sensor responsive to the local water temperature. Another sensor 718-F is a pressure sensor responsive to the local water pressure, which indicates the depth of the sonic head 114′. The output of these sensors 718-E, 718-F are used by the processors 732, 1010 to determine an optimum application configuration or set of operating variables.

Another sensor 718-G is a light sensor responsive to light intensity or luminescence in the water 102 surrounding the sonic head 114′. In one embodiment, the light sensor 718-G has an output used by the processors 732, 1010 to control the power output of the transducers 714 and/or other operating parameters. For example, in some application configurations the power of the transducers 714 is increased during period of increased light, such as experienced during daytime hours. In one embodiment, the output of the solar panel 124 provides the same function as the light sensor 718-G.

Another sensor 718-H is a fluorometric sensor that is responsive to various micro-organisms, oils, and other material in the water 102. The fluorometric sensor 718-H identifies the presence and quantity of specific molecules in the water 102 such that the presence and amount of specific micro-organisms is available to the processor 732. The processor 732 then uses the presence and quantity information from the fluorometric sensor 718-H to determine the duty cycle, period, and number and intensity (power) of frequencies to be emitted by the various transducers 714, 402. The fluorometric sensor 718-H, in one embodiment, provides information on harmful algae blooms (HABs) to the processor 732 for the processor 732 to determine the parameters for exciting the various transducers 714, 402.

As used herein, the processors 1010, 732 should be broadly construed to mean any device that accepts inputs and provides outputs based on the inputs and the programming of the device. For example, each of the processors 1010, 732 is a micro-controller, application specific integrated circuit (ASIC), an analog control device, or a computer or component thereof that executes software. In various embodiments, each of the processors 1010, 732 is one of a specialized device or a computer for implementing the functions of the invention. Each of the processors 1010, 732 includes input/output (I/O) units for communicating with external devices and a processing unit that varies the output based on one or more input values. Computer-based processors 1010, 732 include a memory medium that stores software and data and a processing unit that executes the software. Those skilled in the art will recognize that the memory medium associated with the computer-based processors 1010, 732 can be either internal or external to the processing unit of the processors 1010, 732 without departing from the scope and spirit of the present invention.

The processors 1010, 732 work independently and in tandem. In one embodiment, the processor 1010 in the power unit 122′ stores information on various pre-defined application configurations. The processor 1010 also receives and stores new and revised application configurations from the remote device 1024. When a specific application configuration is selected, such as locally from the selector switch 1012 or the keypad 1016, or remotely from the remote device 1024, the processor 1010 communicates with the driver processor 732, which stores the selected application configuration. The driver processor 732 executes its programming in accordance with the selected application configuration. The driver processor 732 provides status and sensor information to the power unit processor 1010, which is programmed to respond and process such information.

In one embodiment, the algae control system 100 emits ultrasonic waves 314, 304 with a predetermined duty cycle, period, frequency set (or playlist), for a series. A duty cycle is defined as a cycle consisting of an on time and an off time. The sum of the on time and off time is one period. That is, the time for one cycle is a period. For example, a transducer 714, 402 that is emitting an ultrasonic wave 314, 304 for 0.4 seconds and is not emitting a wave 314, 304 for 0.6 seconds has a 40 percent duty cycle and a period of one second. Each set of transducers 714, 402 and each group 402-A, 402-B, 402-C emits ultrasonic waves 314, 304 at a single frequency at a time, with the frequency changing for every period. The frequency set, or playlist, is a collection of frequencies that are sequentially emitted by each set of transducers 714, 402 and each group 402-A, 402-B, 402-C. In various embodiments, the frequencies in the frequency set are in increasing order, decreasing order, random order, or some preselected order. In one such embodiment, the frequencies are emitted sequentially with an order optimized for inducing turbulence or disrupting the microorganisms.

In one example, a frequency set includes 10,000 discrete frequencies within the operating range of the set of transducers 714, 402 or a group 402-A, 402-B, 402-C. Each set of transducers 714, 402 and each group 402-A, 402-B, 402-C has a frequency set specific to that set of transducers 714, 402 and group 402-A, 402-B, 402-C. For an embodiment with a first set of transducers 714 and one group 402-A for the second set of transducers 402, two frequency sets are emitted simultaneously. That is, the first set of transducers 714 emits one frequency set specific to the frequency range of that set 714 at the same time that the second set of transducers 402-A emits one frequency set specific to the frequency range of that set 402-A. A series is defined as a collection of frequency sets, which, in this case, the series has two frequency sets. After both frequency sets are emitted, the series is completed and another series begins.

With a period of one second and two sets of transducers 714, 402, a frequency set with 10,000 frequencies takes 10,000 seconds, or 2.8 hours, to emit the full frequency set. That is, the first set of transducers 714 emits a frequency set of 10,000 frequencies and the second set of transducers 402 with one group 402-A emits a frequency set of 10,000 frequencies. In this way, 20,000 ultrasonic waves 318, 304 are emitted for a full series. A series is the total frequency sets or playlists emitted by the sonic head 114. A series is the sum of the frequencies emitted by each set of transducers 714, 402 and each group 402-A, 402-B, 402-C. Each series is emitted by the sonic head 114 sequentially with no break between sequential series. Turbulence is simulated or mimicked by emitting ultrasonic waves 314, 304 of varying on/off or duty cycles, periods, and frequencies with multiple series.

In one embodiment, the first set of transducers 714 operate with a frequency range between 22 kHz and 250 kHz and the second set of transducers 402 operate with a frequency range between 400 kHz and 2,000 kHz. In one such embodiment, the second set of transducers 402 includes multiple groups of transducers 402-A, 402-B, 402-C where the frequency range between 400 kHz and 2,000 kHz is divided between the groups 402-A, 402-B, 402-C. For example, the first group 402-A has an operating range of 400 kHz to 600 kHz, the second group 402-B has an operating range of 900 kHz to 1.1 kHz, and the third group has an operating range of 1.5 MHz to 2.0 MHz. In this example, the second set of transducers 402 with the three groups 402-A, 402-B, 402-C have three frequency sets with each frequency set including only frequencies within the operating frequency for its associated group 402-A, 402-B, 402-C.

In another embodiment, the first set of transducers 714 operate with a frequency range selected from a group of frequency ranges of 18-20 kHz, 24-58 kHz, and 190-210 kHz and the second set of transducers 402 operate with a frequency range selected from a group of frequency ranges of 400 to 700 kHz and 400-800 kHz.

In one embodiment, the transducers in each set of transducers 714, 402 and each group 402-A, 402-B, 402-C are excited simultaneously to emit the same sonic wave 314, 304 having the same duty cycle, period, power, and frequency. In another embodiment, the transducers in each set of transducers 714, 402 and each group 402-A, 402-B, 402-C are excited independently with different duty cycles, period, and frequency sets. For example, one transducer 714-A is emitting a sonic wave 314 with a first duty cycle, first period, first power, and first frequency set and the second transducer 714-B is emitting a sonic wave 314 with a second duty cycle, second period, second power, and second frequency set wherein one or both of the duty cycle, period, power, and/or frequency are different between the two transducers 714-A, 714-B.

In one embodiment, multiple sonic heads 114′ are wired in parallel. In such an embodiment, the sonic heads 114′ are suspended at various depths below the surface 104. For example, for a fish net that is suspended thirty meters below the surface 104, two or three sonic heads 114′ are suspended at depths with ten meter intervals. In this way, the multiple sonic heads 114′ work to control algae growth on the fish net.

FIG. 12 illustrates a partial, cross-sectional view of a first embodiment of a transducer 402′. The illustrated transducer 402′ is selected from the second set of transducers 402. In the illustrated embodiment, the transducer 402′ includes one end of a piezoelectric crystal 404′ attached to a block 406′. One face 1204f of the crystal 404′ is received in a recess 1208 of one block 406′. The crystal 404′ is secured in the recess 1208 by an adhesive 1210 that fills the gap between the face 1204f of the crystal 404′ and the bottom face 1206f of the recess 1208. The adhesive 1210 also fills the gap between the side 1204s of the crystal 404′ and the sidewall 1206s of the recess 1208. In this way, the adhesive 1210 transfers the vibrations from the crystal 404′ to the block 404 for both the radial mode vibrations 1212-R and the axial mode vibrations 1212-A.

The face opposite the face 1204f of the crystal 404 is adhered to the inside surface 216i of the housing 216. In this way the crystal 404′ is mechanically coupled to the radiating surface 322 of the housing 216 and to the block 406′.

FIG. 13 illustrates an exploded diagram of a second embodiment of a transducer 402″ showing the attachment of the transducer 402″ to a section of the housing 216′. The transducer 402″ has a block 406″ with a piezoelectric element 404″ positioned between the inside surface 216i of the housing 216 and the block 406″.

In the illustrated embodiment, the bolt 1302 has a head 1304, and a threaded portion 1306. The distal end of the threaded portion 1306 engages a nut 1308. The nut 1308, and any washers 1312, 1318, fit in a recess 1506 on the outer surface of the block 406″. In this way, the bolt 1302 and nut 1308, when tightened, compress the piezoelectric element 404″. The bolt 1302 with the nut 1308 and washer 1318 compresses the crystal 404″ between the housing 216 and the block 406″. In the illustrated embodiment, the transducer 402″ does not rely on an adhesive to ensure a good electrical and mechanical contact between the block 406″ and the piezoelectric element 404″. Instead, the illustrated embodiment of the transducer 402″ relies upon the compression from the fastener 1302, 1308 to ensure a good electrical and mechanical contact between the block 406″ and the piezoelectric element 404″. The compressive force from the fastener 1302, 1308 allows for both the radial mode and the axial or thickness extension mode of operation of the crystal 404″.

In another embodiment, the shoulder washer 1312 is not used and the bolt 1302 is not electrically insulated from the block 406″. In one such embodiment, the washer 1318 and the nut 1308 engage the threaded portion 1306 of the bolt 1302 inside the recess 1506. In another embodiment, the washer 1318 and the nut 1308 engage the threaded portion 1306 of the bolt 1302 with the washer 1318 adjacent the outer, planar surface of the block 406″. In yet another embodiment, the block 406″ does not have the outer recess 1506 and the hole 1504 is threaded to engage the threaded portion 1306 of the bolt 1302. In such an embodiment, the nut 1308 is not necessary as the block 406″ performs the fastening function. In various such embodiments, the hole 1504 is either a blind hole or a through-hole.

In one embodiment, the block 406″ does not have an inner recess 1208. In such an embodiment, the face 404f of the element 404″ is in contact with the inner surface of the block 406″. In one such embodiment, the surface 404f of the element 404″ and the inner surface of the block 406″ are both planar.

The piezoelectric element 404″ is electrically connected to the circuit board 410 by way of electrical connections or conductors 412-A, 412-B. In one embodiment, the connection 412-B to the block 406″ is by way of a fastener securing a terminal to the block 406″, such as illustrated in FIG. 5.

The block 406″ is electrically connected to one face 404f of the piezoelectric element 404″. In one embodiment in which the housing 216 is a non-conductive material, a conductive material 1320 is positioned between the piezoelectric element 404′ and the inside face 216i of the housing 216. The conductive material 1320 is an electrically conductive sheet, such as a copper foil, that makes electrical contact to an adjacent face 404f of the piezoelectric elements 404″. A conductor 412-A is electrically connected to the material 1320. In this way, the one face 404f of the piezoelectric element 404″ is at a first potential while the opposing face 404f is at a second potential. The conductors 412-A, 412-B are in electrical communication with the exciter 734 associated with the driver 716. In an embodiment in which the housing 216 is a conductive material, the conductor 412-A is electrically connected to the housing 216 and the conductive material 1320 is not used. In another embodiment in which the housing 216 is a conductive material, the bolt 1302, the bolt head 1304, and the crystal 404″ are electrically insulated from the housing 216 such as with insulating washers and/or an insulating shoulder washer separating the bolt 1302, the bolt head 1304, and the crystal 404″ from the housing 216.

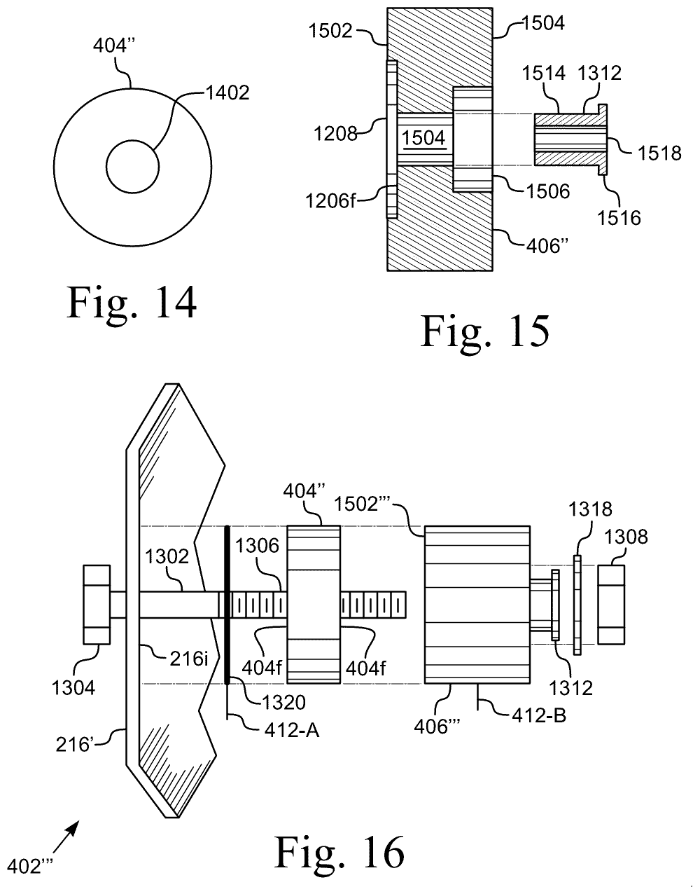

FIG. 14 illustrates a plan view of the second embodiment of a piezoelectric element 404″. The illustrated embodiment of the element 404″ has a donut-shape with a through-opening 1402 in the center. The through-opening 1402 is sized to receive the threaded portion 1306 of the bolt 1302. In the embodiment illustrated in FIG. 15, the through-opening 1402 is sized to receive a distal end of the bushing portion 1514 of the shoulder washer 1312, thereby electrically insulating the bolt 1302 from the element 404″.

FIG. 15 illustrates a cross-sectional view of the second embodiment of a block 406″. In the illustrated embodiment, the block includes an inner recess 1208, a through-hole 1504, and an outer recess 1506. The inner recess 1208 receives a corresponding end of the crystal 404″ that includes face 304f. The illustrated through-hole 1504 receives the bushing portion 1514 of the shoulder washer 1312. The bushing portion 1514 receives the threaded portion 1306 of the bolt 1302. The outer recess 1506 receives the shoulder portion 1516 of the shoulder washer 1312, the washer1318, and the nut 1308.

The shoulder washer 1312 provides insulation between the bolt 1402 and nut 1408 and the block 406″ and crystal 404″. In the illustrated embodiment, a flange portion 1516 of the shoulder washer 1312 is positioned adjacent the washer 1318 and the nut 1308, and the bushing portion 1514 of the shoulder washer 1312 is positioned between the threaded portion 1306 of the bolt and the block 406″ and the element 404″. In this way, the bolt 1302 is electrically isolated from both the crystal 404″ and the block 406″.

The shoulder washer 1312 is an electrically insulating material, such as nylon or some other polymer material. The shoulder washer 1312 has a through-hole 1518 sized to receive the threaded portion 1306 of the bolt 1302. The shoulder washer 1312 has a bushing portion 1514 and a flange portion 1516. The bushing portion 1514 of the shoulder washer 1312 engages the through-hole 1504 in the block 406″. The flange portion 1516 of the shoulder washer 1312 engages the outer recess 1506 in the block 406″ and, thereby, at least a portion of the crystal 404″. When an insulated shoulder washer 1312 is used, the bolt 1302 and nut 1308 are insulated from the block 406″ and the crystal 404″.

FIG. 16 illustrates an exploded diagram of a third embodiment of a transducer 402″' from the second set of transducers 402. The illustrated embodiment is similar to that shown in FIG. 13 except that the block 406″' has the same diameter as the piezoelectric crystal 404″, such as illustrated in FIG. 6. In such an embodiment, the block 406″' does not include an inner recess 1208 as shown in FIG. 15. Instead, the surface 1502″' is planar with a central through-opening 1504 that receives the bolt 1302 and the shoulder washer 1312.

The algae control system 100 includes various functions. The function of providing substantially 360 degree coverage in a plane parallel with the surface 104 of the body of water 102 is implemented, in one embodiment, by each set of transducers 714, 402 having ultrasonic transmitting surfaces oriented at 90 degree intervals radially. With the ultrasonic waves 304, 314 having a distribution angle 302 of at least 90 degrees, the four ultrasonic transmitting surfaces provide 360 degrees of coverage. In another embodiment, the function of providing substantially 360 degree coverage in a plane parallel with the surface 104 of the body of water 102 is implemented by a piezoelectric element 1206 having a set of radiators 1212 attached to an outer surface of the element 1206 such that the radiators 1212 emit ultrasonic waves with 360 degree coverage. Additionally, the emitted wave fans out vertically as the wave travels away from the transducers 714.

The function of controlling multiple types of microorganisms is implemented, in one embodiment, by the transducers 402, 714 emitting sonic waves 304, 314 at the critical structural resonant frequencies coincident with the microorganism to be controlled by internal damage. In one such embodiment, the function of controlling both green algae and diatom algae, along with blue-green algae, is implemented by the first set of transducers 714 in the sonic head 114 emitting sonic waves 314 at a first frequency range between 24 and 58 kHz and at a second frequency range between 195 and 205 kHz.

The function of providing multiple sonic heads 114′ connected to a single power unit 122′ is implemented, in one embodiment, by a single cable 126 that includes an extension 1028 for each sonic head 114 after the first one. In one such embodiment, the extension 1028 includes conductors that connect the first end connector 226 in parallel with the other end connectors 226′.

The function of providing algae control over a vertical column is implemented, in one embodiment, by multiple sonic heads 114′ suspended vertically below the surface 104 of the body of water 102. In one such embodiment, the function is implemented by an extension cable 1028 connecting one sonic head 114′ to another, lower sonic head 114′, thereby allowing the sonic heads 114′ to be vertically displaced.

From the foregoing description, it will be recognized by those skilled in the art that a transducer unit 110 for controlling algae in bodies of water 102 has been provided. The transducer unit 110 includes a sonic head 114. In one embodiment, the sonic head 114 includes two sets of transducers 714, 402 where each set 714, 402 is oriented to provide 360 degrees of coverage around the sonic head 114.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for controlling microorganisms in a body of water, said apparatus comprising:
a first set of transducers with a plurality of first radiating surfaces, each one of said plurality of first radiating surfaces having a first axis extending perpendicularly away from said each one of said plurality of first radiating surfaces, each one of said first set of transducers configured to emit a first ultrasonic wave along said first axis where said first ultrasonic wave subtends an angle at least equal to one half of an angle between adjacent ones of said first axes whereby said first set of transducers emit said first ultrasonic waves 360 degrees around said first set of transducers;
a second set of transducers with a plurality of second radiating surfaces, each one of said plurality of second radiating surfaces having a second axis extending perpendicularly away from said each one of said plurality of second radiating surfaces, each one of said second set of transducers configured to emit a second ultrasonic wave along said second axis where said second ultrasonic wave subtends an angle at least equal to one half of an angle between adjacent ones of said second axes whereby said second set of transducers emit said second ultrasonic waves 360 degrees around said second set of transducers; and
a driver circuit electrically connected to said first set of transducers and said second set of transducers, said driver circuit exciting said first set of transducers within a first frequency range and exciting said second set of transducers within a second frequency range, whereby said first frequency range including a critical structural resonant frequency for a first type of algae, said second frequency range including a critical structural resonant frequency for a second type of algae.

2. The apparatus of claim 1 further including a sonic head that includes said first and second set of transducers, said sonic head having a head axis that is configured to be vertical when said sonic head is submerged in a liquid, said sonic head further including a housing with at least four walls where each one of said at least four walls is parallel to said head axis, each second transducer of said second set of transducers including a piezoelectric element each secured to an inside surface of one of said at least four walls of said housing, an outside surface of said housing proximate each one of said second transducers defining one of said second radiating surfaces.

3. The apparatus of claim 1 further including a first sonic head that includes said first and second set of transducers, a second sonic head that includes a third and fourth set of transducers, and said second sonic head connected to said first sonic head with an extension cable having a length greater than a selected distance between said first and second sonic heads when deployed in the body of water whereby said first and second sonic head are operatively controlled by a single processor.

4. The apparatus of claim 3 wherein said extension cable is connected in parallel with a plurality of conductors connected between said driver circuit and said first sonic head.

5. The apparatus of claim 1 wherein said first set of transducers includes a first sonic transducer and a second sonic transducer wherein each one of said first and second sonic transducers include a pair of blocks with a piezoelectric element therebetween, said first sonic transducer having a first axis and said second sonic transducer having a second axis, and said first axis being perpendicular to said second axis.

6. The apparatus of claim 1 further including a feedback sensor responsive to said first ultrasonic waves emitted by said first set of transducers and to said second ultrasonic waves emitted by said second set of transducers, and said feedback sensor detecting a failure of any one transducer in said first and second sets of transducers.

7. The apparatus of claim 1 further including an electrical cable connecting a remote power unit to said driver circuit, said electrical cable having a first connector half configured to connect to a second connector half electrically connected to said driver circuit, said first connector half including a moisture sensor responsive to water in a space between said first connector half and said second connector half when said first and second connector halves are engaged.

8. The apparatus of claim 1 wherein said first set of transducers emits ultrasonic waves having a frequency less than 220 kHz and said second set of transducers emits ultrasonic waves having a frequency greater than 220 kHz.

9. The apparatus of claim 8 wherein said second set of transducers includes a plurality of groups of transducers, each one of said plurality of groups of transducers operating with a frequency range different than the frequency range of other ones of said plurality of groups of transducers.

10. The apparatus of claim 1 wherein said first set of transducers emits ultrasonic waves having a frequency range selected from a group of frequency ranges of 18-20 kHz, 24-58 kHz, and 190-210 kHz and said second set of transducers emits ultrasonic waves within a frequency range of 400-800 kHz.

11. The apparatus of claim 1 wherein said second set of transducers includes a plurality of groups of transducers, each one of said plurality of groups of transducers including four transducers positioned to emit ultrasonic waves at 90 degree intervals around a vertical axis of a sonic head that includes said first and second set of transducers, and said sonic head configured to be vertical when said sonic head is submerged in a liquid.

12. The apparatus of claim 1 wherein each one of said second set of transducers includes a piezoelectric element, a block, a fastener, a nut, and a shoulder washer; each said piezoelectric element has a donut-shape with an element through-opening that is centrally located; each said block includes a block through-opening with a distally positioned recess; said shoulder washer engages said block through-opening and said distally positioned recess; said shoulder washer being an electrically insulating material whereby said fastener and said nut are electrically insulated from said piezoelectric element and said block when said fastener and said nut compress said piezoelectric element and said block.

13. An apparatus for controlling microorganisms in a body of water, said apparatus comprising:
a sonic head having at least one first enclosure and a second enclosure, said sonic head configured to be submerged in water, said sonic head having a vertical axis when submerged in water;
a first set of transducers having four first radiating surfaces, each one of said four first radiating surfaces having a first axis extending perpendicularly away from said each one of said four first radiating surfaces, each one of said four axes being perpendicular to said vertical axis, each one of said four axes being located 90 degrees away from an adjacent one of said four axes, each one of said first set of transducers configured to emit a first ultrasonic wave along said first axis where said first ultrasonic wave subtends an angle at least equal to one half of an angle between adjacent ones of said first axes whereby said first set of transducers emit said first ultrasonic waves 360 degrees around said vertical axis;
a second set of transducers with a plurality of second radiating surfaces, each one of said plurality of second radiating surfaces having a second axis extending perpendicularly away from said each one of said plurality of second radiating surfaces, each one of said second set of transducers configured to emit a second ultrasonic wave along a corresponding one of said second axis where said second ultrasonic wave subtends an angle at least equal to one half of an angle between adjacent ones of said second axes whereby said second set of transducers emit said second ultrasonic waves 360 degrees around said vertical axis; and
a driver circuit electrically connected to said first set of transducers and said second set of transducers, said driver circuit exciting said first set of transducers within a first frequency range and exciting said second set of transducers within a second frequency range, whereby said first frequency range including a critical structural resonant frequency for a first type of algae, said second frequency range including a critical structural resonant frequency for a second type of algae.

14. The apparatus of claim 13 wherein said second set of transducers includes a plurality of groups of transducers, each one of said plurality of groups operating independently, each one of said plurality of groups including transducers positioned around said vertical axis whereby adjacent ones of a cone of radiation emitted from each of said transducers in each one of said plurality of groups overlap so as to provide 360 degrees of coverage around said vertical axis.

15. The apparatus of claim 13 further including a feedback sensor responsive to each of said first ultrasonic waves emitted by said first set of transducers and to each of said second ultrasonic waves emitted by said second set of transducers, and said feedback sensor detecting a failure of any one transducer in said first and second sets of transducers.

16. The apparatus of claim 13 further including an electrical cable connecting said driver circuit to a remote power unit, said electrical cable having a first connector half configured to connect to a second connector half electrically connected to said driver circuit, said first connector half including a moisture sensor responsive to water in a space between said first connector half and said second connector half when said first and second connector halves are engaged.

17. An apparatus for controlling microorganisms in a body of water, said apparatus comprising:
a sonic head configured to be submerged in water, said sonic head having a vertical axis when submerged in water;
a plurality of transducers, each one of said plurality of transducers being an ultrasonic transmitter;
a driver circuit electrically connected to said plurality of transducers, said driver circuit including at least one exciter connected to said plurality of transducers; and
a sensor responsive to ultrasonic vibrations emitted by said plurality of transducers, said sensor detecting a condition where one of said plurality of transducers fails to properly transmit an ultrasonic wave,
whereby said sensor provides data on the operability of said sonic head.

18. The apparatus of claim 17 wherein said plurality of transducers includes a plurality of groups of transducers in which each one of said plurality of groups of transducers emits ultrasonic waves with 360 degrees of coverage around said vertical axis.

19. The apparatus of claim 18 wherein each one of said plurality of groups of transducers emits a frequency set with each emitted frequency having a preselected duty cycle, a preselected period, a preselected power, and a plurality of preselected frequencies.

20. The apparatus of claim 18 wherein each one of said plurality of groups of transducers emits a frequency set unique to said one of said plurality of groups of transducers.

21. An apparatus for controlling microorganisms in a body of water, said apparatus comprising:
a sonic head having at least one first enclosure and a second enclosure, said sonic head configured to be submerged in water, said sonic head having a vertical axis when submerged in water;
a first set of transducers having two first radiating surfaces, each one of said two first radiating surfaces having a first axis extending perpendicularly away from said each one of said two first radiating surfaces, said first axis being perpendicular to said vertical axis, said first set of transducers configured to emit a first ultrasonic wave along said first axis;
a second set of transducers with a plurality of second radiating surfaces, each one of said plurality of second radiating surfaces having a second axis extending perpendicularly away from said each one of said plurality of second radiating surfaces, each one of said second set of transducers configured to emit a second ultrasonic wave along said second axis where said second ultrasonic wave subtends an angle at least equal to one half of an angle between adjacent ones of said second axes whereby said second set of transducers emit said second ultrasonic waves 360 degrees around said vertical axis; and
a driver circuit electrically connected to said first set of transducers and said second set of transducers, said driver circuit exciting said first set of transducers within a first frequency range and exciting said second set of transducers within a second frequency range, whereby said first frequency range including a critical structural resonant frequency for a first type of algae, said second frequency range including a critical structural resonant frequency for a second type of algae.

22. The apparatus of claim 21 wherein said first set of transducers includes another two first radiating surfaces, each one of said another two first radiating surfaces having another first axis extending perpendicularly away from said each one of said another two first radiating surfaces, said first axis being perpendicular to said vertical axis, said first set of transducers configured to emit a first ultrasonic wave along said first axis, where said first ultrasonic wave subtends an angle at least equal to one half of an angle between adjacent ones of said first axes whereby said first set of transducers emit said first ultrasonic waves 360 degrees around said vertical axis.
